(19) United States
(12) Patent Application Publication
(10) Pub. No.: US 2005/0047138 A1
(43) Pub. Date: Mar. 3, 2005

(54) Fluorescent light diffuser

(76) Inventor: Christoph Rochna, Belair (AU)

Correspondence Address: ROBERT A. PARSONS, 340 E. PALM LN, SUITE 260, PHOENIX, AZ, 85004, US

(21) Appl. No.: 10/932,621

(22) Filed: Sep. 2, 2004

(30) Foreign Application Priority Data
Sep. 3, 2003 (AU) 2003904766

(51) Int. Cl. F21K 2/00

(52) U.S. Cl. 362/260

(57) ABSTRACT

A light diffuser includes a first elongated flexible sheet of material having a plurality of composite openings spaced regularly along the length thereof with each composite opening including two adjacent apertures and a connecting slot extending therebetween. The slots are provided to form cheeks on opposite sides thereof and the apertures are formed to receive a fluorescent tube therethrough. The cheeks are deformable to allow the lateral insertion of the fluorescent tube through the slot and into the two adjacent apertures after which the cheeks return to an original position to hold the fluorescent tube in the two adjacent apertures. A second elongated flexible sheet of material has serpentine edges and laterally outwardly extending tabs formed in the serpentine edges. The tabs are positioned to be engaged, one each, in the longitudinally extending slots in the first sheet to engage the second sheet with the first sheet.

### CROSS-REFERENCE TO RELATED APPLICATIONS

This application claims the benefit of Australian Provisional Application Number 2003904766, filed 3 Sep. 2003.

### FIELD OF THE INVENTION

This invention relates to the field of light diffusers for light fittings, and in particular to diffusers for use with fluorescent tubes.

### BACKGROUND OF THE INVENTION

It is known to light domestic living areas with light fittings employing fluorescent tubes. These types of lighting have the advantage that they are economical to operate. The light provided by a fluorescent tube is bright and clear, but many people find this light unpleasant. A further problem is that bare fluorescent tubes are generally considered to be ugly or aesthetically undesirable. The holders into which the fluorescent tubes are mounted or electrically connected are also generally considered to be ugly or unsightly. The holders are of necessity quite large, since they must accommodate the length of the fluorescent tubes (generally two because of the flicker rate) and the additional electrical components required to strike the discharge tubes.

In many instances covers, which attach to the tube holders, are provided and may also perform a diffuser function. However, unlike incandescent globe lighting fixtures, where a pseudo-standard has evolved for the attachment of shades or covers or diffusers to the lighting fixtures, fluorescent tube holders have no standard methods for attachment of shades, covers, or diffusers. Many fluorescent tube holders are not equipped with any means for attaching a diffuser at all. Those which are so equipped are usually designed only to accommodate the particular diffuser which is supplied with the fluorescent tube holder of purchase. Thus, it is difficult to economically provide a range of fluorescent tube covers or light diffusers as an after market accessory. In order to change the appearance of a fluorescent tube lighting fixture, it is or may be necessary to replace the entire fitting. This reduces the ability of a user to personalize the appearance of a fluorescent light fixture as may be done for an incandescent light fixture using the very wide range of lamp shades available on the market.

It is known to provide diffusers which are woven over or have the fluorescent tube threaded through openings therein. An example of this type of diffuser is disclosed in U.S. Pat. No. 6,231,212, entitled “Fluorescent Lamp Baffle”, issued 15 May 2001. A major problem with this type of structure is that the fluorescent tubes must be removed from the lamp, inserted or threaded through the baffle, and then reassembled in the lamp or light fixture. This complicated mounting arrangement is extremely inconvenient to assemble and substantially limits the shape of the baffle and the configurations that can be devised.

It would be highly advantageous, therefore, to remedy the foregoing and other deficiencies inherent in the prior art.

Accordingly, it is an object of the present invention to provide a new and improved fluorescent light diffuser.

Another object of the invention is to provide a new and improved fluorescent light diffuser that is easy to assemble on substantially any fluorescent tube lighting fixture.

Another object of the invention is to provide a new and improved fluorescent light diffuser that can be easily varied in outward appearance.

Still another object of the present invention is to provide a new and improved fluorescent light diffuser that can easily be provided in a large variety of aesthetically pleasing and widely varying configurations.

### SUMMARY OF THE INVENTION

Briefly, to achieve the desired objects of the instant invention in accordance with a preferred embodiment thereof, provided is a light diffuser comprising at least one flexible sheet of material having a plurality of regularly spaced apertures formed therein for receiving a fluorescent tube therethrough and each aperture having a slot extending from one of an adjacent aperture and an adjacent edge of the flexible sheet of material into communication with the aperture to form opposed cheeks adjacent the slots. The cheeks are deformable to allow the lateral insertion of the fluorescent tube through the slot and into the aperture after which the cheeks return to an original position to hold the fluorescent tube in the aperture. Thus, the light diffuser can be quickly and easily installed with no difficult unplugging of a fluorescent tube and complicated threading through openings.

In one embodiment, a light diffuser includes a first elongated flexible sheet of material having a plurality of composite openings spaced regularly along a length thereof with each composite opening including two adjacent apertures and a connecting slot extending therebetween. The slots are provided to form opposed cheeks on opposite sides thereof and the apertures are formed to receive a fluorescent tube therethrough. The cheeks are deformable to allow the lateral insertion of the fluorescent tube through the slot and into the two adjacent apertures after which the cheeks return to an original position to hold the fluorescent tube in the two adjacent apertures. The first elongated flexible sheet further includes longitudinally extending slots spaced laterally outwardly on opposite sides from the plurality of composite openings. The light diffuser further includes a second elongated flexible sheet of material with serpentine edges and laterally outwardly extending tabs formed in the serpentine edges. The tabs are positioned to be engaged, one each, in the longitudinally extending slots to engage the second flexible sheet with the first flexible sheet in an assembled unit.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a perspective view of a light diffuser in accordance with the present invention illustrating a normal use;

FIG. 2 is a plan view of a first flexible sheet of the light diffuser of FIG. 1, showing it in a flat state before installation;

FIG. 3 is a plan view of a second flexible sheet of the light diffuser of FIG. 1, showing it in a flat state before installation;

FIG. 4 is a cross-sectional view of the light diffuser of FIG. 1 in the installed position;

FIG. 5 is a perspective view of a portion of the light diffuser of FIG. 1 showing only the first flexible sheet installed;

FIG. 6 is a perspective view of another embodiment of a light diffuser in accordance with the present invention; and

FIG. 7 illustrates an enlarged detailed portion of the light diffuser of FIG. 6.

### DETAILED DESCRIPTION OF THE PREFERRED EMBODIMENT

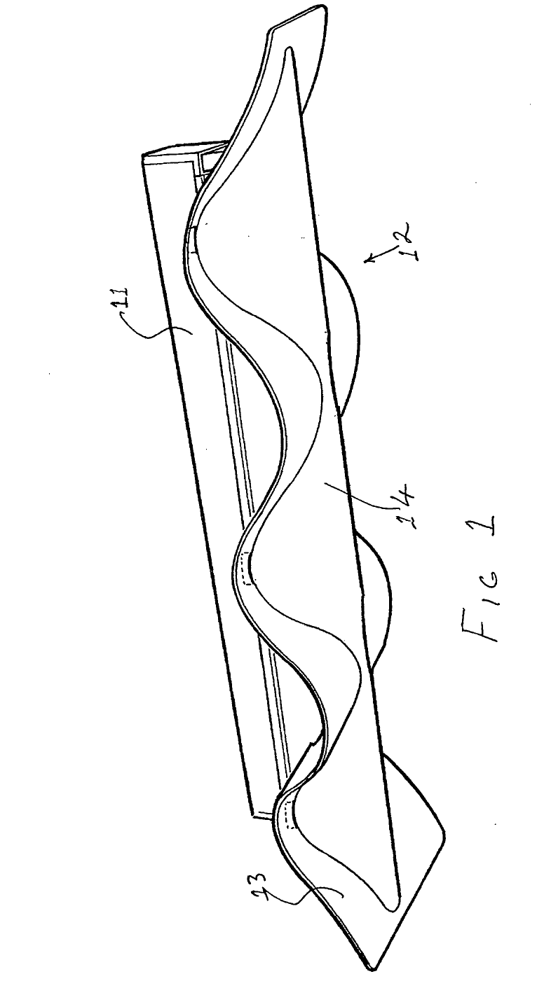

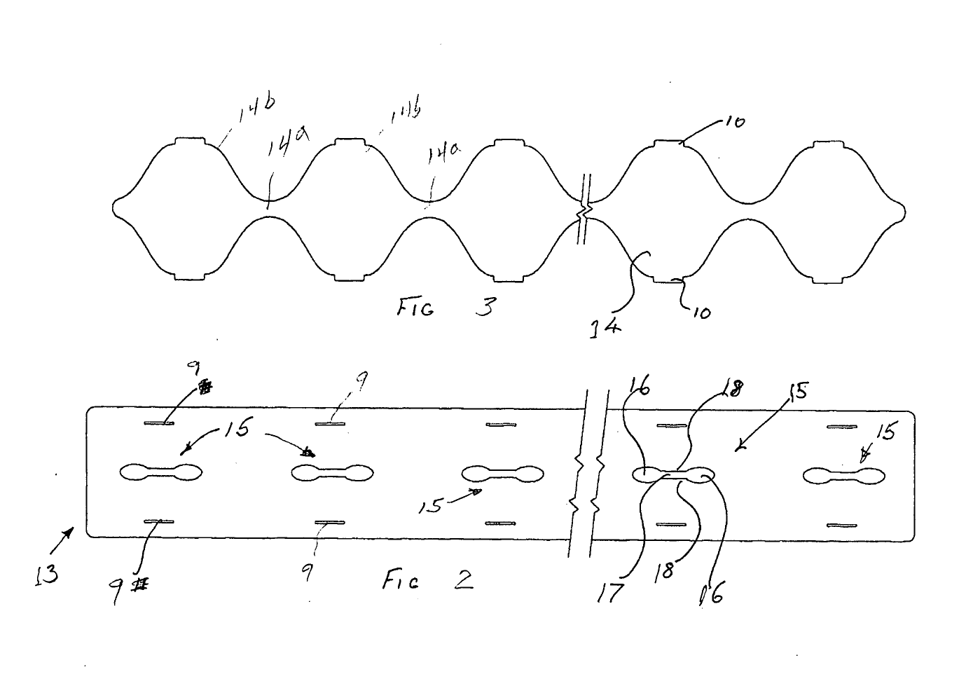

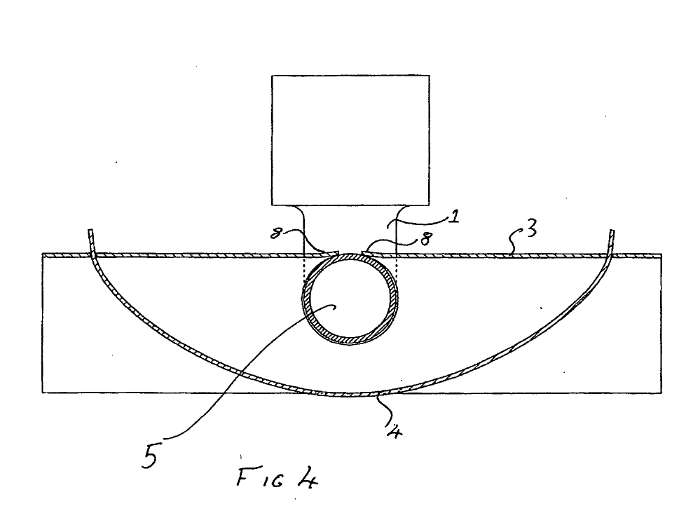

Turning now to the drawings, attention is first directed to FIG. 1, which illustrates a fluorescent tube lighting fixture or fluorescent tube holder 11 with a light diffuser 12 mounted thereon, in accordance with the present invention. In this embodiment, light diffuser 12 includes a first flexible sheet 13 and a second flexible sheet 14. Sheets 13 and 14 are initially provided as flat sheets as illustrated in FIGS. 2 and 3, respectively. Sheets 13 and 14 can be provided, for example, in a flat pack form for ease in storage and transportation. Further, sheets 13 and 14 are, preferably, translucent or transparent and may be provided in white or any desirable color. Also, sheets 13 and 14 are flexible and may be formed of any of a large variety of flexible resilient plastic materials.

Referring additionally to FIG. 2, a plan view of first flexible sheet 13 is illustrated. A plurality of openings (five in this example), generally designated 15, are formed along the length of first flexible sheet 13. Each opening 15 includes a pair of spaced apart apertures 16, joined by an axially extending slot 17. By making apertures 16 larger than slots 17, inwardly directed cheeks 18 are formed on opposite sides of slots 17. Additionally, a pair of slots 9 are formed laterally outwardly, adjacent the outer edges, one each on opposite sides of each opening 15.

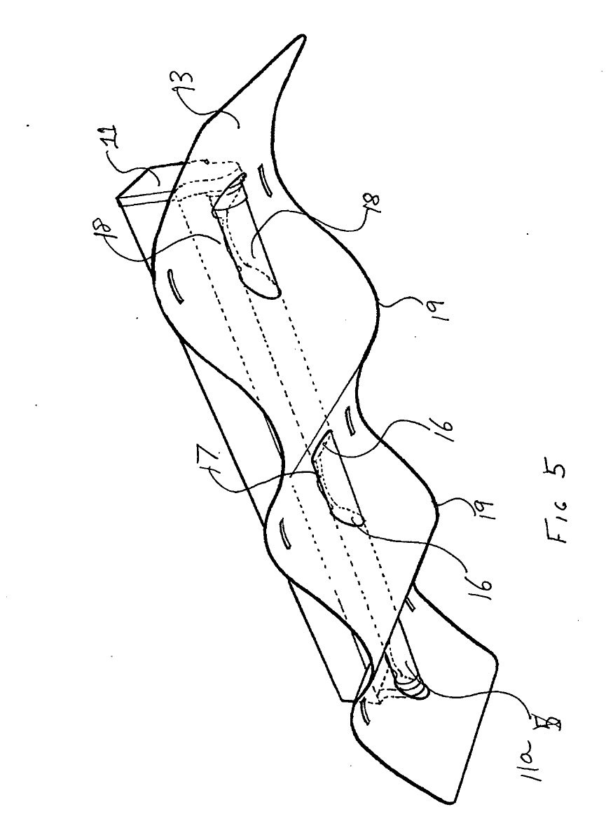

As can be seen best in FIG. 5, fluorescent tube 11a of fluorescent tube holder 11, is positioned in both apertures 16 of each of the openings 15 by the expansion of slot 17 and the deformation of cheeks 18. That is, cheeks 18 are opened or spread apart so as to extend partially around, generally behind, fluorescent tube 11a and to allow fluorescent tube 11a to be positioned in or extend through each of apertures 16, as can be seen in FIG. 4. Because of the flexibility and resilience of first flexible sheet 13, cheeks 18 are caused to be urged against fluorescent tube 11a, thus gripping fluorescent tube 11a and supporting light diffuser 12. The combination of apertures 16 and slots 17 forming openings 15 are repeated several times along the length of first flexible sheet 13. Each combination forming openings 15 is an attachment point to fluorescent tube 11a for light diffuser 12. Between the attachment points, first flexible sheet 13 is formed into peaks 19 with valleys in between spaced along the length, which provide an attractive three dimensional shape for light diffuser 12. Because fluorescent tubes operate much cooler than, for example incandescent lamps, generally remaining cool to the touch throughout extended use, the support of light diffuser 12 is safe.

Referring additionally to FIG. 3, it can be seen that second flexible sheet 14 is shaped with opposing sides each forming a repeating substantially sinusoidal or serpentine curve along the length thereof. The repeating serpentine curves are 180 degrees out of phase so that narrow bridges 14a are formed between wider peaks 14b. Second sheet 14 is further formed to include a tab 10 at each peak 14b on each opposed side. Tabs 10 are adapted to be inserted into slots 9 in first flexible sheet 13. The serpentine shape of second sheet 14 is adapted to contact the surface of first sheet 13 substantially along its entire length in each of the peaks and troughs formed when first sheet 13 is installed onto fluorescent tube 11a. Also, in this embodiment, the lateral spacing of slots 9 is such as to provide second sheet 14 with a partially rolled or curved surface extending lengthwise, as can be seen in either FIG. 1 or FIG. 4. The total combination of curves forms aesthetically pleasing light diffuser 12, as illustrated in FIG. 1. Further, light diffuser 12 can be quickly and easily installed with no difficult unplugging of fluorescent tube 11a and complicated threading through openings.

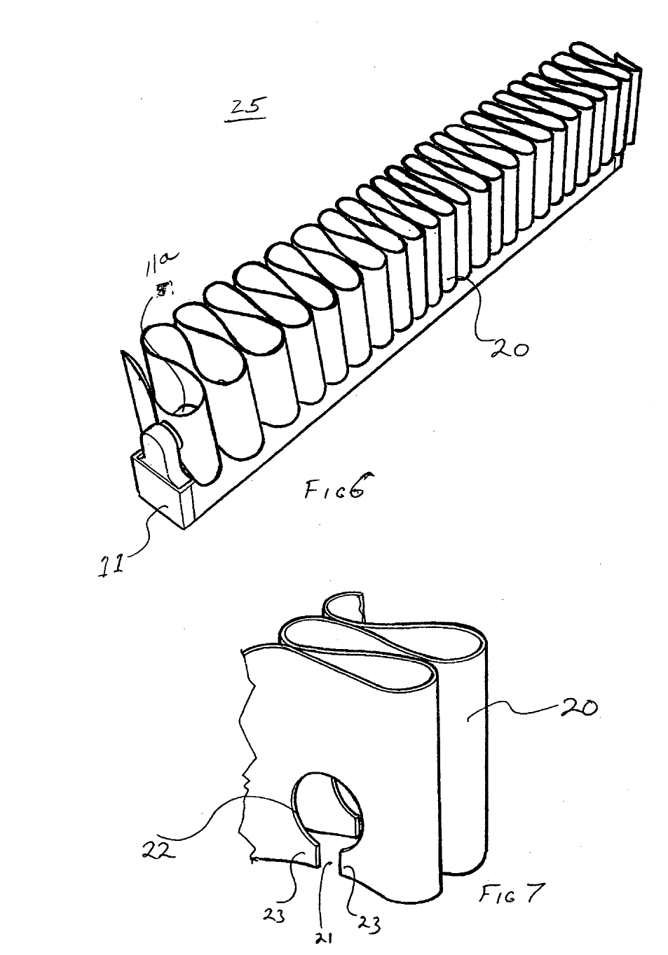

Turning now to FIGS. 6 and 7, another embodiment is illustrated of a light diffuser 25, in accordance with the present invention. Light diffuser 25 includes a flat flexible sheet 20 of material that is gathered into convoluted folds arranged laterally therealong. Each fold is attached directly to fluorescent tube 11a of fluorescent lighting fixture or lamp 11 by attachment apertures 22, best seen in FIG. 7. Each aperture 22 is adjacent to but spaced from the lower edge of sheet 20. A slot 21 is formed in sheet 20 to link aperture 22 to the outsider lower edge and to form cheeks 23 on opposite sides of slot 21.

In use or for installation purposes, cheeks 23 are deformed to allow fluorescent tube 11a to be inserted into aperture 22. Cheeks 23 are then allowed to return to their original or normal position in which they grip fluorescent tube 11a and hold light diffuser 25 firmly in place, as illustrated in FIG. 6. Here it must be noted that fluorescent tube 11a does not need to be removed to install light diffuser 25 thereon. Thus, light diffuser 25 can be quickly and easily installed with no difficult unplugging of fluorescent tube 11a and complicated threading through openings.

It will be understood that specific embodiments have been used for illustrative purposes but other embodiments may be envisaged in which the decorative capacity of the diffuser is enhanced by surface decoration of other and/or additional flexible sheets. The light diffuser might also be used to provide for advertising or character merchandising visual content. From the above description it will be understood by those skilled in the art that a large variety of light diffusers can be devised that will not only produce aesthetically pleasing and widely varying configurations but will provide a personalized appearance of a fluorescent light fixture. Thus, a new and improved light diffuser is disclosed that can be easily varied in outward appearance. Further, the new and improved light diffuser can easily be provided in a large variety of aesthetically pleasing and widely varying configurations.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

1. A light diffuser comprising at least one flexible sheet of material having a plurality of regularly spaced apertures formed therein for receiving a fluorescent tube therethrough and each aperture having a slot extending from one of an adjacent aperture and an adjacent edge of the flexible sheet of material into communication with the aperture to form opposed cheeks adjacent the slots, the cheeks being deformable to allow the lateral insertion of the fluorescent tube through the slot and into the aperture after which the cheeks return to an original position to hold the fluorescent tube in the aperture.

2. A light diffuser as claimed in claim 1 wherein the at least one flexible sheet is formed of a flexible, resilient plastic.

3. A light diffuser as claimed in claim 2 wherein the at least one flexible sheet is one of translucent and transparent.

4. A light diffuser as claimed in claim 1 wherein each slot extends between two adjacent apertures to form a composite opening including the two apertures and connecting slot, and a plurality of the composite openings are formed along a length of the at least one flexible sheet.

5. A light diffuser as claimed in claim 4 wherein the plurality of composite openings are spaced to form the at least one flexible sheet into a plurality of waves and valleys spaced along the length thereof.

6. A light diffuser as claimed in claim 5 wherein the at least one flexible sheet further includes longitudinally extending slots spaced laterally outwardly on opposite sides from the plurality of composite openings, and further includes a second flexible sheet with serpentine edges and laterally outwardly extending tabs formed in the serpentine edges, the tabs being positioned to be engaged, one each, in the longitudinally extending slots to engage the second flexible sheet with the at least one flexible sheet in a single unit.

7. A light diffuser as claimed in claim 6 wherein the longitudinally extending slots are positioned so that the second flexible sheet is partially rolled along the length.

8. A light diffuser as claimed in claim 6 wherein the at least one flexible sheet and the second flexible sheet cooperate to substantially completely cover the fluorescent tube held in the apertures.

9. A light diffuser as claimed in claim 1 wherein the at least one flexible sheet is gathered into convoluted folds arranged laterally along the sheet and each convoluted fold includes an aperture with a slot extending from an adjacent edge of the at least one flexible sheet of material into communication with the aperture.

10. A light diffuser comprising:
a first elongated flexible sheet of material having a plurality of composite openings spaced regularly along a length of the first elongated flexible sheet with each composite opening including two adjacent apertures and a connecting slot extending therebetween, the slots are provided to form opposed cheeks on opposite sides thereof and the apertures are formed to receive a fluorescent tube therethrough, the cheeks being deformable to allow the lateral insertion of the fluorescent tube through the slot and into the two adjacent apertures after which the cheeks return to an original position to hold the fluorescent tube in the two adjacent apertures, the first elongated flexible sheet further includes longitudinally extending slots spaced laterally outwardly on opposite sides from the plurality of composite openings; and
a second elongated flexible sheet of material with serpentine edges and laterally outwardly extending tabs formed in the serpentine edges, the tabs being positioned to be engaged, one each, in the longitudinally extending slots to engage the second flexible sheet with the first flexible sheet in an assembled unit.

11. A light diffuser as claimed in claim 10 wherein the plurality of composite openings are spaced to form the first flexible sheet into a plurality of waves and valleys spaced along the length thereof.

12. A light diffuser as claimed in claim 11 wherein the longitudinally extending slots are positioned so that the second flexible sheet is partially rolled along the length.

13. A light diffuser as claimed in claim 10 wherein the at least one flexible sheet and the second flexible sheet cooperate to substantially completely cover the fluorescent tube held in the apertures.

14. A light diffuser as claimed in claim 10 wherein the first and second flexible sheets are formed of a flexible, resilient plastic.

15. A light diffuser as claimed in claim 14 wherein the first and second flexible sheets are one of translucent and transparent.

16. A light diffuser as claimed in claim 10 wherein the first and second flexible sheets are provided as flat sheets.
